(19) United States
(12) Patent Application Publication
(10) Pub. No.: US 2004/0097209 A1
(43) Pub. Date: May 20, 2004

(54) Automatic gain control apparatus and methods

(76) Inventors: David R. Haub, Crystal Lake, IL (US); Louis J. Vannatta, Crystal Lake, IL (US); Mahibur Rahman, Lake Worth, FL (US)

Correspondence Address: MARSHALL, GERSTEIN & BORUN (MOTOROLA), 233 SOUTH WACKER DRIVE, SUITE 6300, CHICAGO, IL, 60606-6402, US

(21) Appl. No.: 10/294,145

(22) Filed: Nov. 14, 2002

(51) Int. Cl. H04B 1/06; H04B 7/00

(52) U.S. Cl. 455/242.1; 455/234.2; 455/240.1; 455/246.1

(57) ABSTRACT

An automatic gain control system is provided. A signal path is configured to receive an input signal. The signal path includes a first amplifier that has a control input. A first signal level detector is coupled to the signal path, the first signal level detector having a signal level output. A gain control device having a first signal level input is coupled to the signal level output of the first signal level detector. The gain control device also has a first control output coupled to the control input of the first amplifier, and a gain control configuration input. A processor, coupled to the gain control configuration input of the gain control device, is configured to monitor operating conditions and to reconfigure the gain control device in response to changes in the operating conditions.

### TECHNICAL FIELD

The present disclosure relates to communication systems, and more particularly to automatic gain control in communication receivers.

### BACKGROUND

Third generation (3G) wireless communication systems promise to provide a whole new array of high-speed mobile services. 3G networks have been launched in Japan and other countries, and may soon be launched in the United States. 3G technology presents difficulties for designers of 3G cellular receivers.

For instance, in 3G wireless systems (which are based on wide-band code division multiple access (CDMA) technology) it is desirable for a gain control system in a 3G receiver to behave linearly. It is often difficult, however, for gain control systems of typical radio cellular receivers employing continuous gain amplifiers to meet linearity requirements.

### BRIEF DESCRIPTION OF THE DRAWINGS

FIG. 1 is a simplified block diagram of a prior art gain control system.

FIG. 2 is a simplified block diagram of a receiver that may utilize embodiments of a gain control system described herein.

FIG. 3 is a simplified block diagram of one embodiment of a gain control system.

FIG. 4 is a simplified block diagram of another embodiment of a gain control system.

FIG. 5 is a simplified flow diagram of one embodiment of a method of operating a gain control system.

FIG. 6 is a simplified block diagram of a receiver employing a specific embodiment of a gain control system.

FIG. 7 is a simplified block diagram of a specific embodiment of a control device of a gain control system.

FIG. 8 is a simplified flow diagram of one embodiment of a method by which control device 640 of FIG. 7 may operate.

FIGS. 9 and 10 are simplified flow diagrams of one specific embodiment of a method for adjusting a step gain of a receiver such as receiver 600 of FIG. 6.

FIG. 11 is a simplified block diagram illustrating a system that may include an embodiment of an automatic gain control system.

FIG. 12 is a simplified flow diagram of one embodiment of a method that may be used by gain control management software 1012 of FIG. 11 for generating configuration information.

### DETAILED DESCRIPTION

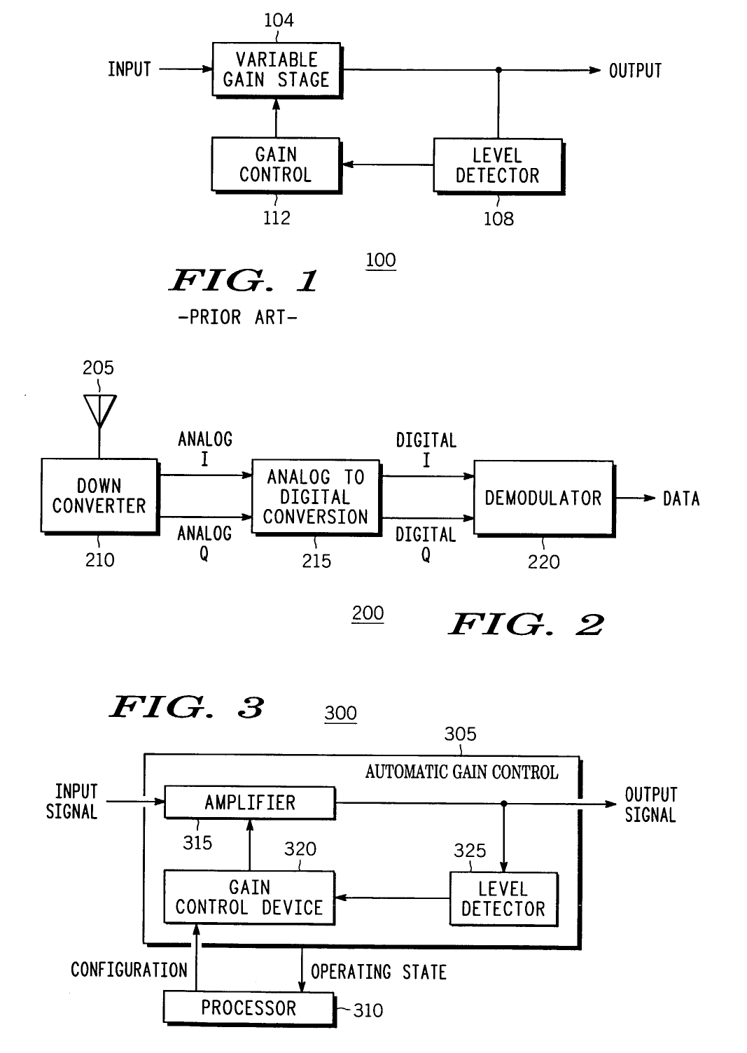

FIG. 1 is a simplified block diagram illustrating a typical prior art gain control system used in cellular receivers. Gain control system 100 includes a variable gain stage 104, a level detector 108, and a gain control device 112. Variable gain stage 104 amplifies the input to produce an output. The amount of amplification is controlled by a control signal generated by gain control device 112. Level detector 108 generates a signal that indicates the signal level of the output of variable gain stage 104. Based on this signal, gain control device 112 controls the gain of variable gain stage 104. For example, if the output of level detector 108 is above a threshold, then gain control device 112 may reduce the gain of variable gain stage 104. Similarly, if the output of level detector 108 is below the threshold, then gain control device 112 may increase the gain of variable gain stage 104.

Gain control system 100 may behave non-linearly when variable gain stage 104 approaches its maximum and/or minimum gain. For instance, near the center point of its operation, a change x in the control input may cause a change 100x in the gain of variable gain stage 104. But near its maximum gain, a change x in the control input may cause a change 5x in the gain of variable gain stage 104.

Additionally, cellular systems based on CDMA handle the well known “near/far” problem using power control. In power control, mobile units in a cell adjust their transmit power such that the received power at the cell's base station from each mobile unit is approximately equal to that of each other mobile unit. Typically, a mobile unit adjusts its transmit power based on the strength of the signal it receives from the base station. Thus, in order to perform accurate power control, the mobile unit should be able to generate an accurate indication of the strength of the signal received from the base station, often referred to as the received signal strength indicator (RSSI). However, an accurate RSSI is often difficult to achieve because of the non-linear response of typical continuous variable gain RF amplifiers. For instance, with gain control system 100, RSSI can be estimated based on the control output of gain control device 112. But, because of the non-linear response of gain control stage 104, the estimate of RSSI might be poor.

As with other cellular systems, when it is desired to maximize quality of service, a 3G cellular receiver may attempt to maximize the signal-to-noise ratio (SNR). Typically, SNR can be increased by increasing the receiver's gain. On the other hand, when a cellular receiver encounters high power interference, it may attempt to reduce distortion caused by the interference. Typically, distortion from high power interference can be reduced by reducing the receiver's gain. Thus, it would be desirable for a cellular receiver to be flexible enough to adjust its gain upwards when, for example, increased SNR is desired, and to reduce its gain when, for example, it encounters high power interference.

Embodiments described herein provide apparatus and methods for providing gain control. In some embodiments, a gain control system includes a configurable gain control device that may be reconfigured when operating conditions change. For example, in a cellular receiver, initial operating conditions may indicate that high-powered interference is present. Therefore, the configurable gain control device may initially be configured to provide reduced gain in order to avoid distortion caused by clipping. Later, operating conditions may indicate that the high-powered interference is no longer present. Thus, the configurable gain control device may be reconfigured to provide increased gain in order to increase the signal-to-noise ratio and improve reception.

FIG. 2 is a simplified block diagram illustrating an example of a receiver system in which embodiments described herein may be employed. Receiver system 200 includes an antenna 205, a downconverter 210, an analog-to-digital converter 215, and a demodulator 220. Antenna 200 receives a radio frequency (RF) signal and provides it to downconverter 210. Downconverter 210 down-converts the RF signal into two analog signals: an in-phase (I) signal, and a quadrature (Q) signal. The analog I and Q signals are converted to digital signals by converter 215 and provided to demodulator 220. Demodulator 220 demodulates the I and Q signals to produce a data signal. It is to be understood that receiver system 200 is merely one example of a system that may employ embodiments described herein. Embodiments may be used in many other systems as well. For example, embodiments can be used in other types of receivers or in transmitters.

FIG. 3 is a simplified block diagram illustrating an automatic gain control system according to one embodiment. Automatic gain control system 300 includes an automatic gain control device 305 coupled with a processor 310. Processor 310 receives operating state information and determines a configuration for automatic gain control device 305 based on that operating state information.

Automatic gain control device 305 includes an amplifier 315 that applies gain to an input signal to produce an output signal. A gain control device 320 controls the amount of gain applied by amplifier 315 based on a signal level detected by level detector 325 and based on the configuration provided by processor 310.

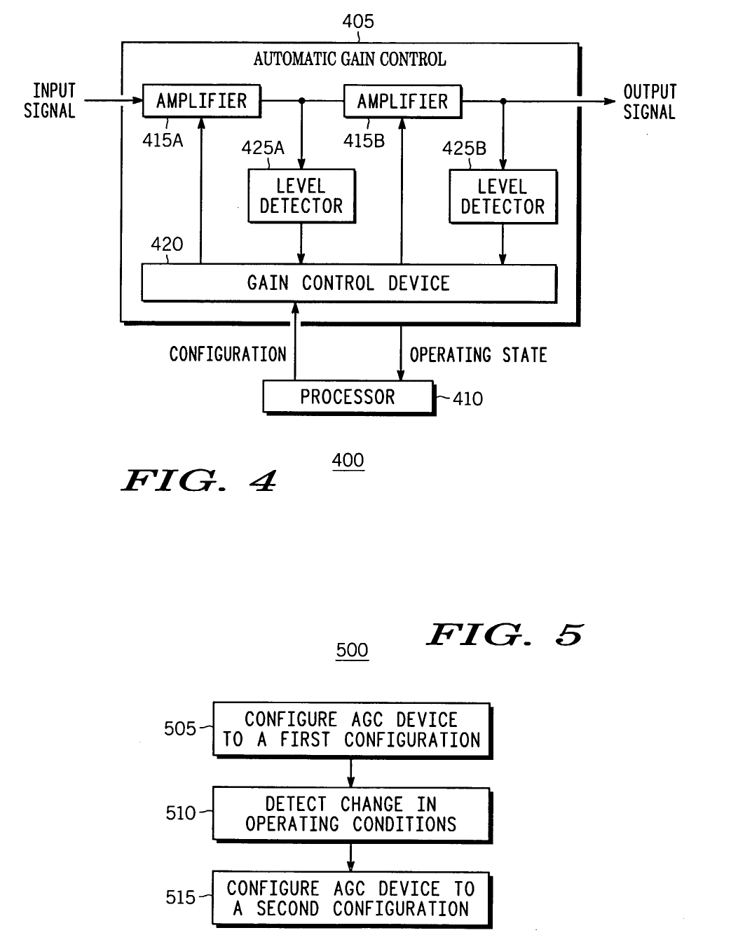

Amplifier 315 may comprise a plurality of amplifiers along a signal path. Similarly, level detector 325 may comprise a plurality of level detectors along a signal path. For instance, FIG. 4 is a simplified block diagram illustrating another embodiment. In the system 400 illustrated in FIG. 4, automatic gain control system 405 includes two amplifiers 415A and 415B. Also included are two level detectors 425A and 425B. Gain control device 420 controls the amount of gain applied by amplifiers 415A and 415B based on signal levels detected by level detectors 425A and 425B and based on the configuration provided by processor 410.

Referring again to FIG. 3, amplifier 315 may include one or more amplifiers in an analog portion of a signal path and one or more amplifiers in a digital portion of the signal path. For example, in FIG. 4, an analog-to-digital conversion (not shown) may occur between amplifiers 415A and 415B, and amplifier 415A may be an analog amplifier and amplifier 415B may be a digital amplifier (e.g., a multiplier).

FIG. 5 is a simplified flow diagram illustrating a method that may be implemented, for example, by automatic gain control systems 300 and 400 of FIGS. 3 and 4, respectively. First, an automatic gain control device is configured to a first configuration (505). The first configuration corresponds to first operating conditions. For example, first operating conditions may indicate a high-power interference. Therefore, the automatic gain control device can be configured to reduce gain such that distortion caused by clipping is reduced. If a change in operating conditions is detected (510), then automatic gain control device is configured to a second configuration (515). The second configuration corresponds to second operating conditions. Continuing the previous example, the high-power interference may cease. Thus, the second operating conditions indicate little interference. Therefore, the automatic gain control device can be reconfigured to increase gain in an attempt to increase a signal-to-noise ratio (SNR). In the above example, the first and second operating conditions may be determined based on the operating state information provided to processor 310/410 (FIGS. 3 and 4).

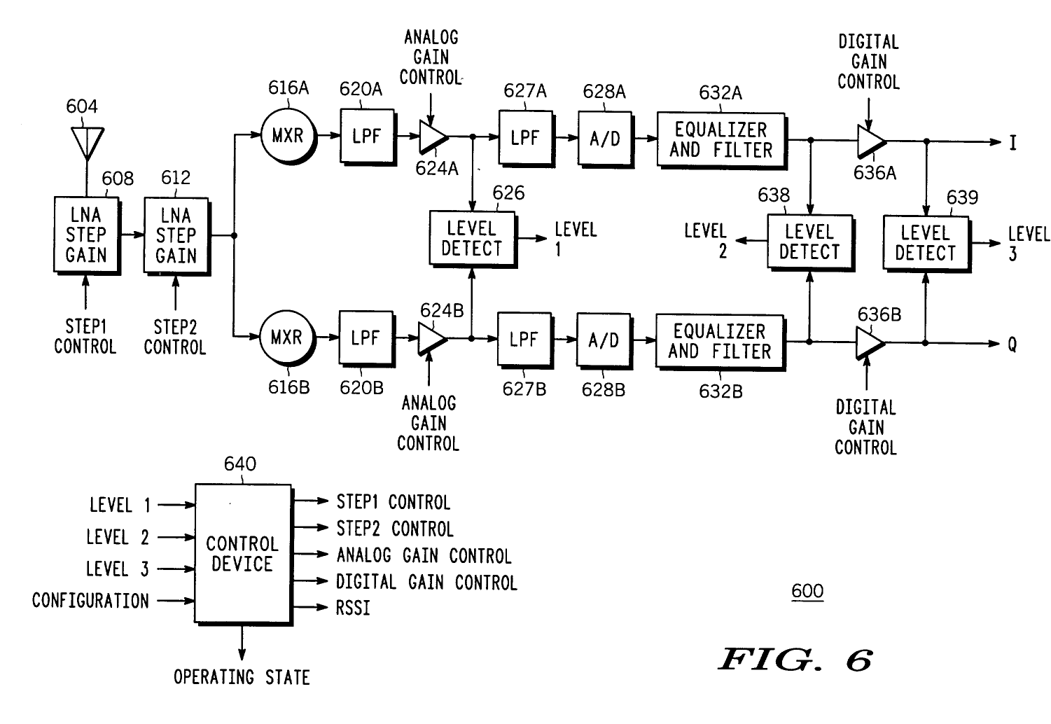

FIG. 6 is a simplified block diagram of an example of an RF receiver. Receiver 600 can be used, for example, to receive CDMA signals. It is to be understood that some details have been omitted from FIG. 6 in order to simplify explanation. For instance, one of ordinary skill in the art will recognize that filters and/or buffers may be needed between some of the blocks illustrated in FIG. 6.

Receiver 600 includes an antenna 604 coupled to a low noise amplifier (LNA) 608. LNA 608 is in turn coupled to a second LNA 612. LNA 608 and LNA 612 each provide a programmable step gain between a high gain and a low gain. Each LNA 608 and 612 can be implemented, for example, with a switch between two active, fixed-gain circuits, or one active circuit with a bypass switch. LNA 608 is switched between high gain and low gain by a control signal (STEP1CONTROL). Similarly, LNA 612 is switched between high gain and low gain by the signal STEP2CONTROL.

The output of LNA 612 is coupled to the inputs of mixers 616A and 616B. The outputs of mixers 616A and 616B are filtered by low pass filters 620A and 620B, respectively. The outputs of filters 620A and 620B are coupled to inputs of variable gain amplifiers 624A and 624B, respectively. The gains of amplifiers 624A and 624B are controlled by a control signal (ANALOG GAIN CONTROL). A level detect device 626 is coupled to the outputs of variable gain amplifiers 624A and 624B and detects the power level in these signals. Level detect device 626 generates an indication (LEVEL 1) of the power level in the outputs of variable gain amplifiers 624A and 624B.

Level detect device 626 may be any type of suitable level detection device. For example, for CDMA applications, level detect device 626 may be a device suitable for detecting the presence of an interfering signal. In some embodiments, level detect device 626 determines an estimate of power in its inputs, and then generates a signal (LEVEL 1) that indicates whether the determined estimate is above or below a power threshold. In one specific embodiment, level detect device 626 determines an estimate of power in the outputs of variable gain amplifiers 624A and 624B, and then generates a signal (LEVEL 1) that indicates whether the determined estimate is above a power range, within the range, or below the range. In these embodiments, LEVEL 1 is a digital signal. Although level detect device 626 is shown in FIG. 1 as generating a signal based on both I and Q inputs, in other embodiments, level detect device 626 may generate a signal based on only an I input, or only a Q input. Further, level detect device 626 may generate a signal based on a weighted average of I and Q inputs.

The outputs of variable gain amplifiers 624A and 624B are coupled to low pass filters 627A and 627B, respectively, which may be, for example, anti-aliasing filters. The outputs of low pass filters 627A and 627B are coupled to the inputs of analog-to-digital converters (ADCs) 628A and 628B, respectively. The digital outputs of ADCs 628A and 628B are coupled with processing blocks 632A and 632B, respectively, which equalize and filter the digital signals. Next, the outputs of processing blocks 632A and 632B are coupled to the inputs of amplifiers 636A and 636B (which may be digital multipliers). The gains of amplifiers 636A and 636B are controlled by a control signal (DIGITAL GAIN CONTROL). The outputs of amplifiers 636A and 636B are digital, gain-controlled I and Q signals, respectively.

A level detect device 638 is coupled with the outputs of processing blocks 632A and 632B. Level detect device 638 generates an indication (LEVEL 2) of the power level in the outputs of processing blocks 632A and 632B. In another embodiment, level detect device 638 can be coupled with the outputs of amplifiers 636A and 636B. In this embodiment, level detect device 638 would generates an indication of the power level in the outputs of amplifiers 636A and 636B.

Level detect device 638 may be any type of suitable level detection device. For example, in one specific embodiment, level detect device 638 generates a thirteen-bit estimate of I²+Q², where I and Q are the inputs to level detect device 638. One skilled in the art will recognize many variations. For instance, in other embodiments, level detect device 638 may generate an estimate of I²+Q² with more or less than thirteen-bits. In still other embodiments, level detect device 638 may generate an estimate of the square root of I²+Q². In still other embodiments, level detect device 638 may generate a level detection signal based on I only, Q only, or a weighted average of I and Q.

Another level detect device 639 is coupled to the outputs of amplifiers 636A and 636B. Level detect device 639 generates an indication (LEVEL 3) of the power level in the output of amplifiers 636A and 636B. Level detect device 639 may be any type of suitable level detection device. For example, level detect device 639 may be a device similar to level detect device 626. In one specific embodiment, level detect device 639 determines an estimate of power in the outputs of amplifiers 636A and 636B, and then generates the signal LEVEL 3 that indicates whether the determined estimate is above a power range, within the power range, or below the power range. In some embodiments, level detect device 639 may generate the signal LEVEL 3 based on I only, Q only, or a weighted average of I and Q.

Receiver 600 also includes a control device 640. Control device 640 is coupled to receive configuration information from a processor (not shown), as well as the indications of signal levels from level detect devices 626 and 640. Using the received configuration information and the indications of signal levels, control device 640 generates control signals for controlling the gain applied by receiver 600. In particular, control device 640 generates control signals STEP1CONTROL and STEP2CONTROL for controlling LNA 608 and LNA 612, respectively. Additionally, control device 640 generates the control signal ANALOG GAIN CONTROL for controlling variable gain amplifiers 624A and 624B. Also, control device 640 generates the control signal DIGITAL GAIN CONTROL for controlling amplifiers 636A and 636B. Further, control device 640 generates a received signal strength indication (RSSI). Control device 640 will be described in more detail below. Additionally, control device 640 may generate OPERATING STATE information. Referring now to FIGS. 3 and 4, the OPERATING STATE information may be provided to processor 310 or 410. The OPERATING STATE information may include, for example, information related to power measurements, signal levels, the state of LNA's 608 and/or 612, etc. The OPERATING STATE information may also include one or more of the other signals generated by control device 640 (i.e., STEP1CONTROL, STEP2CONTROL, ANALOG GAIN CONTROL, DIGITAL GAIN CONTROL, and RSSI).

In operation receiver 600 receives an RF signal via antenna 604. The received signal is filtered (not shown) and amplified by LNA 608 and LNA 612. The amount of amplification applied by LNA 608 and LNA 612 is controlled by control device 640. Then, the RF signal is down-converted to an I signal by mixer 616A and low pass filter (LPF) 620A. Similarly, the RF signal is down-converted to a Q signal by mixer 616B and LPF 620B. If an out-of-band interfering signal was present in the signal received by antenna 604, LPF 620A and LPF 620B attenuate that interference. However, if the interference is of a high power, a significant degree of that out-of-band interference may remain in the output of LPF 620A and LPF 620B.

Next, the I and Q signals are amplified by variable gain amplifiers 624A and 624B, respectively. The gains of variable gain amplifiers 624A and 624B are controlled by control device 640. As described above, out-of-band signals may not be significantly attenuated in the outputs of variable gain amplifiers 624A and 624B. Thus, level detect device 626 provides an indication of the power level of both in-band and out-of-band signals. In particular, level detect device 626 provides an indication to control device 640 of whether a high-power interfering signal is present in the outputs of variable gain amplifiers 624A and 624B. If this indication indicates a high power interfering signal is present, control device 640 may, for example, cause LNAs 608 and/or 612 to go into a low gain state in order to keep processing blocks such as filters and/or ADCs from clipping.

Then, the outputs of variable gain amplifiers 624A and 624B are converted to digital signals by ADCs 628A and 628B, respectively. These digitized signals are equalized and filtered by processing blocks 632A and 632B. Processing blocks 632A and 632B act to further attenuate out-of-band signals. Thus, if an out-of-band interfering signal was present in the signal received by antenna 604, much of that interference is removed from the outputs of processing blocks 632A and 632B.

Because out-of-band signals in the outputs of processing blocks 632A and 632B have been significantly attenuated, level detect device 638 provides an estimate of in-band signal power. This estimate is provided to control device 640. Next, the outputs of processing blocks 632A and 632B are amplified by variable gain amplifiers 624A and 624B, respectively, to produce gain-controlled digital I and Q signals. These signals can be provided, for example, to a demodulator for further processing.

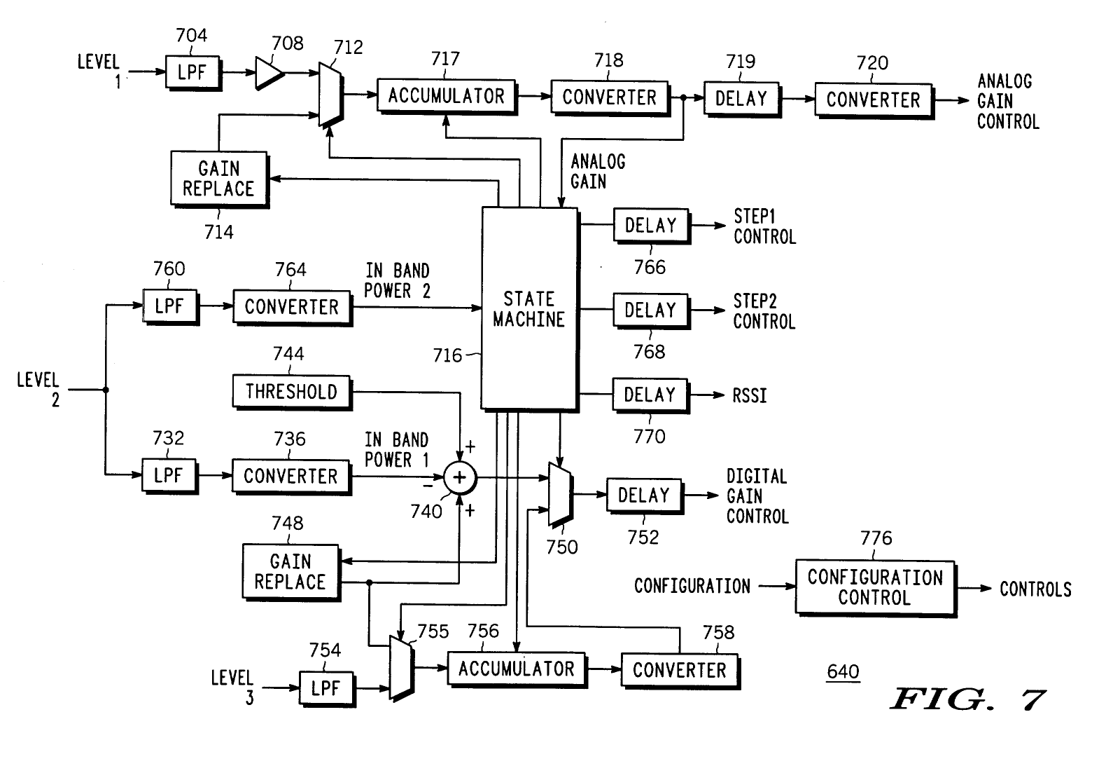

Control device 640 will be described in more detail with reference to FIG. 7. FIG. 7 is a simplified block diagram of one specific embodiment of a control device 640. First, the portion of control device 640 that generates the control signal ANALOG GAIN CONTROL will be described. Control device 640 includes an LPF 704 that filters the indication of power level, LEVEL 1. In this embodiment, the output of LPF 704 is essentially an indication of the moving average of the power in the outputs of variable gain amplifiers 624A and 624B of FIG. 6. The output of LPF 704 is amplified by an amplifier 708 having a programmable gain, and the output of amplifier 708 is coupled to an input of a multiplexer 712. Another input of multiplexer 712 is coupled to a register, memory location, etc., 714 (hereinafter register 714). A control input of multiplexer 712 is coupled with a state machine 716, and an output of multiplexer 712 is coupled with an input of an accumulator 717. An output of accumulator 717 is coupled to the input of a converter 718. Converter 718 converts the output signal of the accumulator 717 from the format generated by level detection device 626 (FIG. 6) into a format suitable for use by state machine 716. The output of converter 718, referred to as ANALOG GAIN, is coupled with state machine 716 and the input of a programmable delay element 719.

The output of the programmable delay element 719 is coupled to the input of a converter 720. Converter 720 may also be controlled by state machine 716. In operation, converter 720 converts the delayed output of converter 718 into a format that can be used to control variable gain amplifiers 624A and 624B (FIG. 6). Converter 720 may employ digital processing and/or analog processing. For example, if variable gain amplifiers 624A and 624B (FIG. 6) are controlled by an analog control input, then the conversion by converter 720 may include converting the delayed digital output of converter 718 into a suitable analog signal.

In operation, LPF 704 filters the signal LEVEL 1 to generate a moving average of LEVEL 1, and amplifier 708 amplifies this signal. If no change in state of LNA 608 and/or LNA 612 has recently occurred, then state machine 716 controls multiplexer 712 to switch the output of amplifier 708 to accumulator 717. Accumulator 717 accumulates the output of multiplexer 712, and state machine 716 resets accumulator 717 at appropriate intervals. Converter 718 converts the output of accumulator 717 into the signal ANALOG GAIN. Programmable delay element 719 delays the signal ANALOG GAIN under the control of state machine 716. This delay can be used, for example, to delay gain changes in order to help avoid transients that may degrade receiver performance. Additionally, converter 720 converts the delayed ANALOG GAIN signal at appropriate intervals under the control of state machine 716.

Referring again to FIG. 6, LNA 608 and LNA 612 each can provide programmable gain in steps. Thus, if the gain state of LNA 608 and/or the gain state of LNA 612 is switched, a substantially instantaneous and significant gain change in the receiver 600 can occur. To minimize this instantaneous gain change, the gains of the variable gain amplifiers 624A or 624B and/or the gains of amplifiers 636A and 636B can be appropriately changed when the gain state of LNA 608 and/or the gain state of LNA 612 is changed in order to compensate for the change in gain. This technique will hereinafter be referred to as “gain replace.”

Referring now to FIGS. 6 and 7, if the gain state of 608 and/or the gain state of LNA 612 is changed, state machine 716 can load an appropriate gain value into register 714. At an appropriate time, state machine 716 controls multiplexer 712 to switch the output of register 714 to accumulator 717. In this way, the signal ANALOG GAIN CONTROL can be adjusted to compensate for step gain changes.

Next, the portion of control device 640 that generates the control signal DIGITAL GAIN CONTROL will be described. As will be described, control device 640 provides an ability to select between a DIGITAL GAIN CONTROL signal generated using two different techniques. These two techniques are referred to below as a “feed forward-type” technique and a “feed back-type” technique. Referring to FIG. 6, the feed forward-type technique generates the DIGITAL GAIN CONTROL signal using the output (LEVEL 2) of level detect device 638, which is “before” amplifiers 636A and 636B. On the other hand, the feed back-type technique generates the DIGITAL GAIN CONTROL signal using the output (LEVEL 3) of level detect device 639, which is “after” amplifiers 636A and 636B.

The portion of control device 640 corresponding to the generation of the DIGITAL GAIN CONTROL signal using the feed forward-type technique will now be described. Control device 640 includes an LPF 732 that filters the indication of power level, LEVEL 2. In this embodiment, the output of LPF 732 is essentially an indication of the moving average of the power in the inputs of amplifiers 636A and 636B of FIG. 6. The output of LPF 732 is converted, using converter 736, from the format generated by level detection device 640 (FIG. 6) into a format suitable for controlling the gain of amplifiers 636A and 636B. The output of converter 736 will be referred to as IN BAND POWER 1. The signal IN BAND POWER 1 is coupled to a subtraction input of an addition device 740. An addition input of addition device 740 is coupled to a register, memory location, etc. 744 (hereinafter “register 744”), and another addition input of addition device 740 is coupled to a register, memory location, etc. 748 (hereinafter “register 748”). Addition device adds the output of register 744 with the output of register 748, and subtracts the output of converter 736 to generate an output signal which is provided to a multiplexer 750. As will be described below, multiplexer can be used to select whether the DIGITAL GAIN CONTROL signal is generated according to the first technique or the second technique Register 744 can be loaded with a desired power level at the output of receiver 600 (FIG. 6). Register 748 can be loaded with a gain replace value if it is desired to replace gain, using amplifiers 636A and 636B, that was switched out from LNA 608 and/or LNA 612 (FIG. 6).

Next, the portion of control device 640 corresponding to the generation of the DIGITAL GAIN CONTROL signal using the feed back-type technique will be described. Control device 640 includes an LPF 754 that filters the indication of power level, LEVEL 3. The output of LPF 754 is coupled with an input of a multiplexer 755. Another input of multiplexer 755 is coupled to the output of register 748. A control input of the multiplexer 755 is coupled with state machine 716, and the output of multiplexer 755 is coupled with an input of accumulator 756. An output of accumulator 756 is coupled to the input of a converter 758, and the output of converter 758 is coupled with an input of multiplexer 750.

In operation, accumulator 756 accumulates the output of multiplexer 755, and state machine 716 resets accumulator 755 at appropriate intervals. Converter 758 converts the output of accumulator 756 to a format suitable for controlling amplifiers 636A and 636B (FIG. 6). The output of LPF 732 is converted, using converter 736, from the format generated by level detection device 640 (FIG. 6) into a format suitable for controlling the gain of amplifiers 636A and 636B.

Referring now to FIGS. 6 and 7, if the gain state of 608 and/or the gain state of LNA 612 is changed, state machine 716 can load an appropriate gain value into register 748. At an appropriate time, state machine 716 controls multiplexer 755 to switch the output of register 748 to accumulator 756. In this way, the signal DIGITAL GAIN CONTROL (generated according to the feed back-type technique) can be adjusted to compensate for step gain changes.

The portion of control device 640 that selects between the feed forward-type technique and the feed back-type technique for generating the signal DIGITAL GAIN CONTROL will be described. Generally, multiplexer 750 receives as its inputs signals corresponding to the DIGITAL GAIN CONTROL signal generated according to the two techniques. A control input of multiplexer 750 is coupled with state machine 716. In this way, state machine 716 can select between the two techniques.

The output of multiplexer 750 is provided to a programmable delay element 752, which delays the output of multiplexer 750 under the control of state machine 716. This delay can be used, for example, to delay gain changes in order to help avoid transients that may degrade receiver performance. The output of programmable delay element 752 is the DIGITAL GAIN CONTROL signal.

In other embodiments, a DIGITAL GAIN CONTROL signal may be generated using only a feed forward-type technique, or using only a feed back-type technique.

Next, the portion of control device 640 that generates the control signals for controlling LNA 608 and LNA 612 (FIG. 6) will be described. Control device 640 includes an LPF 760 that filters the indication of power level, LEVEL 2. In this embodiment, the output of LPF 760 is essentially an indication of the moving average of the power in the inputs of amplifiers 636A and 636B of FIG. 6. The output of LPF 760 is converted, using converter 764, from the format generated by level detection device 640 (FIG. 6) into a format suitable for use by state machine 716. The output of converter 764 will be referred to as IN BAND POWER 2. Generation of the signal IN BAND POWER 2 is similar to generation of the signal IN BAND POWER 1 described above. By generating the signals IN BAND POWER 1 and IN BAND POWER 2 separately, control device can operate more flexibly. In another embodiment, however, only one IN BAND POWER signal need be generated. In this embodiment, the single IN BAND POWER signal can be used for generating the control signal DIGITAL GAIN CONTROL and the control signals for controlling LNA 608 and LNA 612 (FIG. 6).

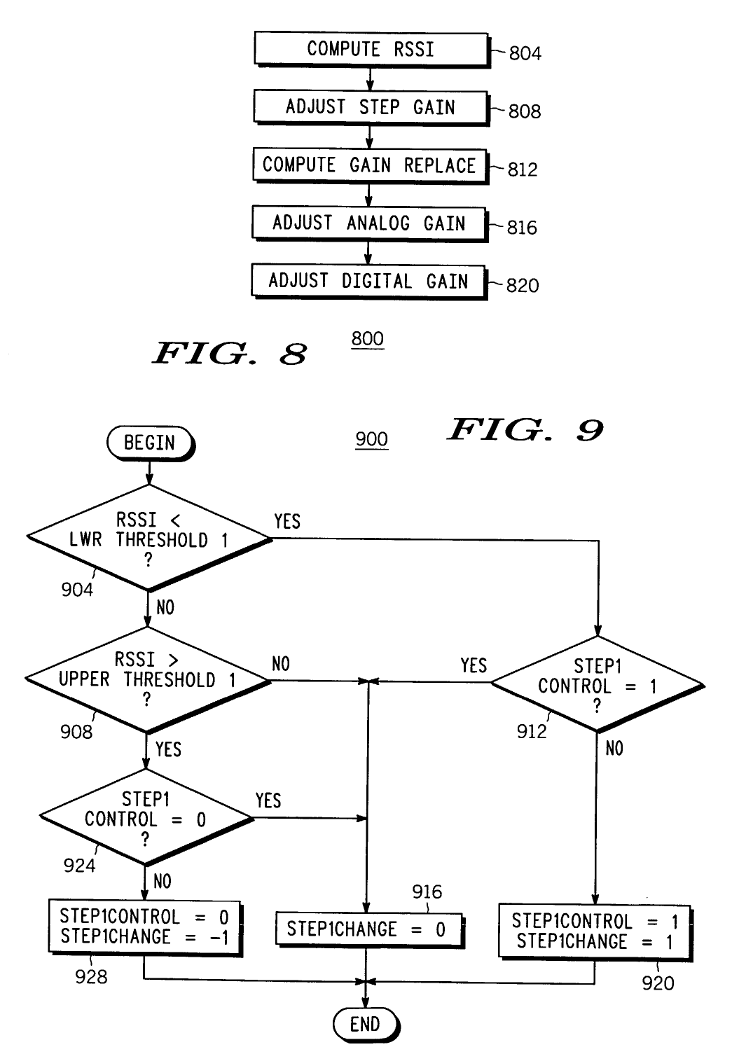

The signal IN BAND POWER 2 is coupled to state machine 716. State machine 716 generates STEP1CONTROL and STEP2CONTROL for controlling LNA 608 and LNA 612 (FIG. 6) using IN BAND POWER 2. In the embodiment in which only a single IN BAND POWER signal is generated, State machine 716 generates STEP1CONTROL and STEP2CONTROL using the IN BAND POWER signal. State machine 716 also generates RSSI. STEP1CONTROL, STEP2CONTROL, and RSSI may be delayed using, for example, programmable delay elements 766, 768, and 770, respectively. These programmable delay elements can be used to time step gain changes to help avoid transients that may degrade receiver performance. One specific embodiment of a method by which state machine 716 operates will be described with reference to FIG. 8.

Control device 640 further includes a configuration control device 776. Configuration control device 776 receives configuration information from a processor (not shown) and, using this configuration information, generates control signals for controlling control device 640. For example, configuration control device 776 may generate control signals (not shown) that control the operation of state machine 716. For instance, these control signals could cause state machine 716 to force LNA 608 and/or LNA 612 into a highest gain state or a lowest gain state. As another example, these control signals could cause state machine 716 to not perform gain replace. Similarly, these control signals could cause state machine 716 to perform gain replace only with respect to the ANALOG GAIN CONTROL signal, or only with respect to the DIGITAL GAIN CONTROL signal. Also, these control signals could cause state machine 716 to perform gain replace using some combination of the ANALOG GAIN CONTROL signal and the DIGITAL GAIN CONTROL signal. Additionally, these control signals could cause state machine 716 to select a particular technique for generating the DIGITAL GAIN CONTROL (state machine 716 can select from the various techniques using multiplexers 750 and 755). Further, these control signals could cause state machine 716 to change delay amounts in various programmable delay elements (e.g., programmable delay elements 719, 752, 766, 768, 770)

Configuration control device 776 may also generate control signals (not shown) that control various elements of control device 640. For example, if a mode of operation is desired in which receiver 600 (FIG. 6) aggressively adjusts its gain, then configuration control device 776 may control, for example, LPF 704, amplifier 708, LPF 760, LPF 732 such that receiver 600 (FIG. 6) quickly adjusts its gain. For instance, in one embodiment, configuration control device 776 may supply filter coefficients to LPF 704, LPF 760, and LPF 732, and may supply a gain value to amplifier 708. In another embodiment, configuration control device 776 may select a set of filter coefficients from two or more sets for each of LPF 704, LPF 760, and LPF 732, and may select a gain value from two or more gain values for amplifier 708. This may be useful, for example, if a receiving device had been powered-down or in a standby mode, and it should power-up and adjust its gain to prepare for receipt of a scheduled transmission. Aggressive gain adjustment should reduce the amount of powered-up time needed by the receiver for preparation, and thus help reduce battery drain.

In another scenario, if a mode of operation is desired in which receiver 600 (FIG. 6) does not aggressively adjust its gain, then configuration control device 776 may control, for example, LPF 704, amplifier 708, LPF 760, LPF 732 such that receiver 600 (FIG. 6) more slowly adjusts its gain. This may be useful, for example, if a receiving device is operating in a steady-state mode.

It will be apparent to one of ordinary skill in the art that configuration control 776 can control various elements of control device 640 either directly, or indirectly, for example, via state machine 716.

FIG. 8 is a simplified flow diagram of one embodiment of a method 800 by which control device 640 of FIG. 7 may operate. First, RSSI is calculated (804). In one specific embodiment, RSSI is calculated as

RSSI=ANALOG GAIN+STEP1CONTROL*STEP1GAIN+STEP2CONTROL*STEP2GAIN+IN BAND POWER 2 (1)

where STEP1CONTROL is 0 or 1 (0 when LNA 608 (FIG. 6) is in its low gain state and 1 when LNA 608 is in its high-gain state), STEP2CONTROL is 0 or 1 (0 when LNA 612 (FIG. 6) is in its low gain state and 1 when LNA 612 is in its high-gain state), STEP1GAIN is the gain of LNA 608 in its high-gain state, and STEP2GAIN is the gain of LNA 612 in its high-gain state. One skilled in the art will recognize many other alternative ways to generate an RSSI.

It has been found that the gain control system of FIGS. 6 and 7 is more linear that typical gain control systems. It has also been found that, because of this higher linearity, the calculation of RSSI as described above provides a more accurate estimate of actual RSSI than similar estimates by typical non-linear gain control systems.

Next, the step gain of receiver 600 (FIG. 6) is adjusted (808). In an embodiment according to FIG. 6, the signals STEP1CONTROL and STEP2CONTROL are generated to control LNA 608 and LNA 612. One embodiment of a method for adjusting the step gains of LNA 608 and LNA 612 (FIG. 6) will be described below.

Then, one or more gain replace values related to the step gains of receiver 600 (FIG. 6) may be calculated (812). In an embodiment according to FIG. 7, the calculated gain replace value or values may then be stored in one or both of registers 714 and 748. In one specific embodiment, a gain replace value may be calculated as:

GAIN REPLACE=STEP1CHANGE * STEP1GAIN+STEP2CHANGE * STEP2GAIN (2)

where STEP1CHANGE may be −1, 0, or 1, STEP2CHANGE may be −1, 0, or +1, and where a value of 0 indicates no change in gain state has occurred, −1 indicates a change in gain state from high-gain to low-gain, and +1 indicates a change in gain state from low-gain to high-gain.

Next, an analog gain of receiver 600 (FIG. 6) is adjusted (816). One embodiment of a technique for adjusting analog gain was described with reference to FIG. 7. In particular, the generation of the signal ANALOG GAIN CONTROL illustrates one technique for adjusting an analog gain of receiver 600 (FIG. 6). It is to be understood that step 816 need not be performed after completion of steps 804, 808, and 812. For example, in some embodiments, step 816 can be performed prior to, or concurrently with any one or more of steps 804, 808, and 812.

Then, a digital gain of receiver (FIG. 6) is adjusted (816). In an embodiment according to FIG. 7, a digital gain is adjusted by periodically generating the signal DIGITAL GAIN CONTROL. As described with respect to FIG. 7, the signal may be generated as:

DIGITAL GAIN CONTROL=THRESHOLD+GAIN REPLACE−IN BAND POWER 1 (3)

where THRESHOLD is an indication, stored in register 744, of a signal power threshold, GAIN REPLACE is a gain replace value stored in register 748, and IN BAND POWER 1 is the output of converter 736. It is to be understood that step 820 need not be performed after completion of steps 804, 808, 812, and 816. For example, in some embodiments, step 820 can be performed prior to, or concurrently with any one or more of steps 804, 808, 812, and 816.

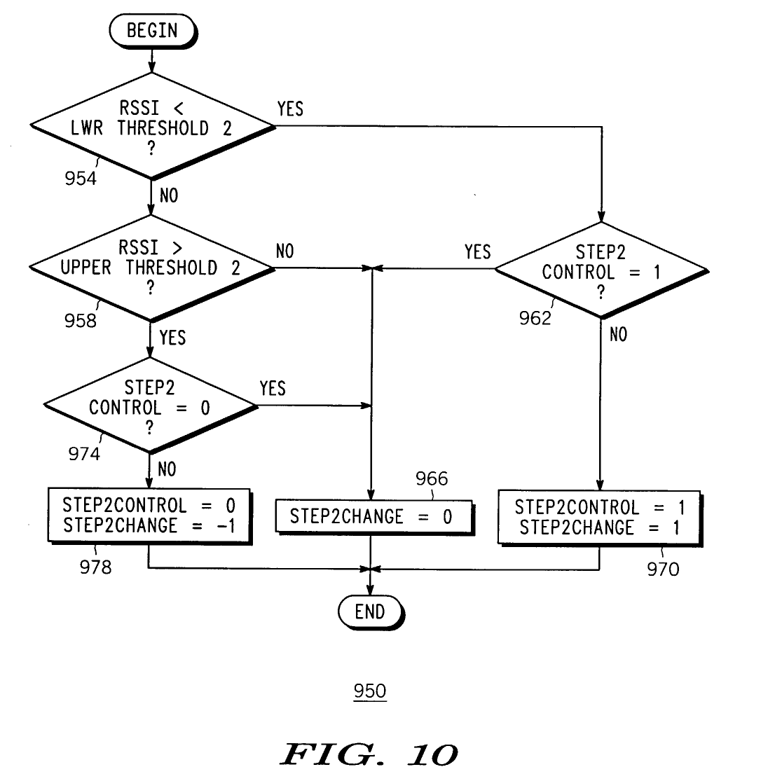

FIGS. 9 and 10 are simplified diagrams of one specific embodiment of a method for adjusting step gain of receiver 600 (FIG. 6). In particular, FIG. 9 illustrates a method 900 for generating control signal STEP1CONTROL for controlling LNA 608 (FIG. 6) and FIG. 10 illustrates a method 950 for generating control signal STEP2CONTROL for controlling LNA 612 (FIG. 6). In this embodiment, if the control signal is set to 0, then the corresponding LNA will be set in a low-gain state. If the control signal is set to 1, then the corresponding LNA will be set in a high-gain state.

First, generation of control signal STEP1CONTROL will be described with reference to FIG. 9. In general, if RSSI is below a lower threshold, then the control signal will be set to 1 to put the LNA in its high-gain state. If RSSI is above an upper threshold, then the control signal will be set to 0 to put the LNA in its low-gain state. If RSSI is between the lower and upper thresholds, then the control signal will be left at its current value.

In step 904, RSSI is compared to a lower threshold (LWR THRESHOLD 1). If RSSI is greater than or equal to LWR THRESHOLD 1, then the flow proceeds to step 908. If RSSI is less than LWR THRESHOLD 1, then the flow proceeds to step 912. In step 912, the current value of STEP1CONTROL is examined. If the current value of STEP1CONTROL is 1, then the flow proceeds to step 916. In 916, the value of STEP1CONTROL is left unchanged. Additionally, a value STEP1CHANGE is set to 0 to indicate that the control signal was not changed.

If in step 912 the current value of STEP1CONTROL was not 1, then the flow proceeds to step 920. In 920, STEP1CONTROL is set to 1 and STEP1CHANGE is set to 1 to indicate that the control signal was changed from 0 to 1.

In step 908, RSSI is compared to an upper threshold (UPPR THRESHOLD 1). If RSSI is greater than UPPR THRESHOLD 1, then the flow proceeds to step 916. If RSSI is less than or equal to UPPR THRESHOLD 1, then the flow proceeds to step 924. In step 924, the current value of STEP1CONTROL is examined. If the current value of STEP1CONTROL is 0 then the flow proceeds to step 916.

If in step 924 the current value of STEP1CONTROL was not 0, then the flow proceeds to step 928. In 928, STEP1CONTROL is set to 0 and STEP1CHANGE is set to −1 to indicate that the control signal was changed from 1 to 0.

Referring now to FIG. 10, the generation of control signal STEP2CONTROL will be described. In step 954, RSSI is compared to a lower threshold (LWR THRESHOLD 2). If RSSI is greater than or equal to LWR THRESHOLD 2, then the flow proceeds to step 958. If RSSI is less than LWR THRESHOLD 2, then the flow proceeds to step 962. In step 962, the current value of STEP2CONTROL is examined. If the current value of STEP2CONTROL is 1, then the flow proceeds to step 966. In 966, the value of STEP2CONTROL is left unchanged. Additionally, a value STEP2CHANGE is set to 0 to indicate that the control signal was not changed.

If in step 962 the current value of STEP2CONTROL was not 1, then the flow proceeds to step 970. In 970, STEP2CONTROL is set to 1 and STEP2CHANGE is set to 1 to indicate that the control signal was changed from 0 to 1.

In step 958, RSSI is compared to an upper threshold (UPPR THRESHOLD 2). If RSSI is greater than UPPR THRESHOLD 2, then the flow proceeds to step 966. If RSSI is less than or equal to UPPR THRESHOLD 2, then the flow proceeds to step 974. In step 974, the current value of STEP2CONTROL is examined. If the current value of STEP2CONTROL is 0 then the flow proceeds to step 966.

If in step 974 the current value of STEP2CONTROL was not 0, then the flow proceeds to step 978. In 978, STEP2CONTROL is set to 0 and STEP2CHANGE is set to −1 to indicate that the control signal was changed from 1 to 0.

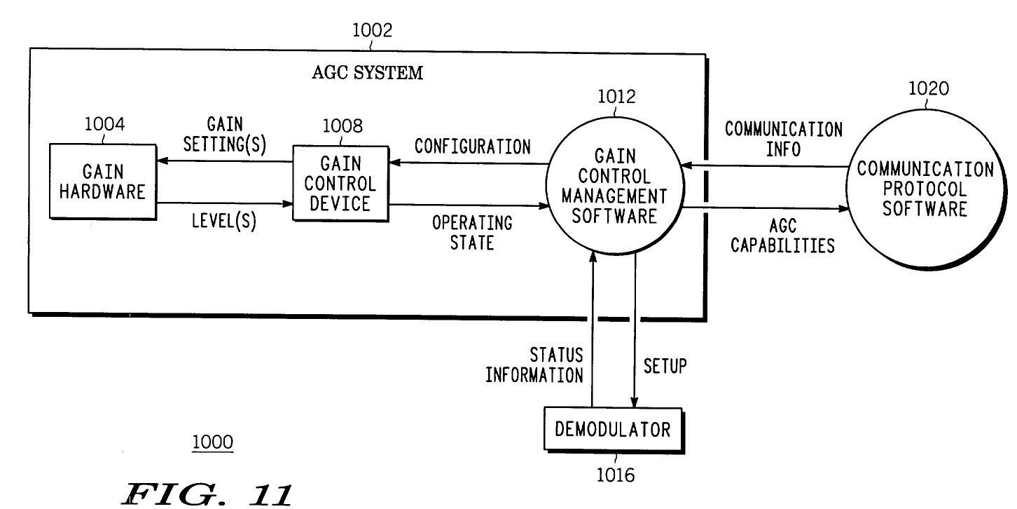

FIG. 11 is a simplified block diagram illustrating a system 1000 that may include an embodiment of an automatic gain control system. System 1000 includes an automatic gain control (AGC) system 1002 comprising gain hardware 1004, a gain control device 1008, and gain control management software 1012 that may be executed, for example, by a general purpose processor, a special purpose processor, a digital signal processor, etc. For example, gain control management software 1012 can be executed by processor 310 or processor 410 of FIGS. 3 and 4, respectively.

Gain hardware 1004 includes one or more amplifiers and one or more level detectors. In various embodiments, the amplifiers and level detectors can operate on analog or digital signals. Several embodiments of gain hardware 1004 were described with reference to FIGS. 3, 4, and 6.

Gain hardware 1004 is coupled with gain control device 1008 and provides to gain control device 1008 one or more indications of signal level. One specific embodiment of gain control device 1008 was described with reference to FIG. 7. Gain control device 1008 is also coupled to receive data from gain control management software 1012. In particular, gain control device 1008 receives configuration information from gain control management software 1012. Using the one or more indications of signal level from gain hardware 1004 and configuration information from gain control management software 1012, gain control device 1008 generates an indication of a gain setting for each of the one or more amplifiers of gain hardware 1004.

Gain control management software 1012 receives operating state information from gain control device 1008. Operating state information can include, for example, RSSI and/or other power measurements. For example, in embodiments that employ a control device such as control device 640 of FIG. 7, operating state information can include power measurements such as IN BAND POWER 1 and IN BAND POWER 2 generated by converters 736 and 764, respectively.

Gain control management software 1012 may receive status information from a demodulator 1016. For example, a demodulator 1016 for use in a cellular receiver may generate data related to channel quality, handoff status, signal-to-interference ratio, etc. Such information can be provided to gain control management software 1012.

Similarly, gain control management software 1012 optionally may receive communication information from communication protocol software 1020. In one embodiment in which system 1000 is used in cellular receiver, communication protocol software 1020 handles one or more levels of cellular communication protocols. In these embodiments, communication protocol software may generate data related to a particular communication protocol currently in use, whether packet-switched or circuit-switched communication is currently in use, the current data rate, etc. Such information can be provided to gain control management software 1012. Communication protocol software 1020 may be executed by the same processor as, or a different processor than, that which executes gain control management software 1012.

Gain control management software 1012 generates configuration information based on the operating state information received from gain control device 1008 and, optionally, the status information received from demodulator 1016 and/or the communication information received from communication protocol software 1020.

Examples of configuration information that can be provided by gain control management software 1012 will be described with reference to FIGS. 6, 7, 9A, and 9B. Configuration information may include gain control threshold values, or indications of threshold values, such as the threshold value stored in register 744 (FIG. 7), LWR THRESHOLD 1, UPPR THRESHOLD 1, LWR THRESHOLD 2, and UPPR THRESHOLD 2 (FIGS. 9 and 10). Additionally, configuration information can include an indication of a gain replacement method. For instance, configuration information may indicate to not implement gain replace, to implement gain replace with analog gain only, to implement gain replace with digital gain only, to implement gain replace with some combination of analog and digital gain, etc. Also, configuration information may include filter setting information. For example, configuration information may include filter settings (e.g., coefficients, bandwidths, cutoffs, etc.), or indications of filter settings, for filters such as filters 620A, 620B, 632A, 632B (FIG. 6), 704, 732, and 760 (FIG. 7).

Configuration information can also include level detector settings for level detectors such as level detectors 626 and 640 (FIG. 6). For instance, one embodiment of a level detector that can be used in some embodiments generates an output that indicates whether the signal power level is below a range, within the range, or above the range, where this range can be set to a desired range. In embodiments using such a level detector, the configuration information can include an indication of this desired range.

In some embodiments, gain control management software 1012 generates indications of the desired configuration and provides this information to gain control device 1008. Then, a device such as configuration control device 776 (FIG. 7) generates control signals, based on the desired configuration, for controlling gain control device 1008. Such control signals can include, for example, gain control threshold values, level detector settings, indication of a gain replacement method, filter settings, etc.

Additionally, gain control management software 1012 optionally may provide information to demodulator 1016 and/or communication protocol software 1020.

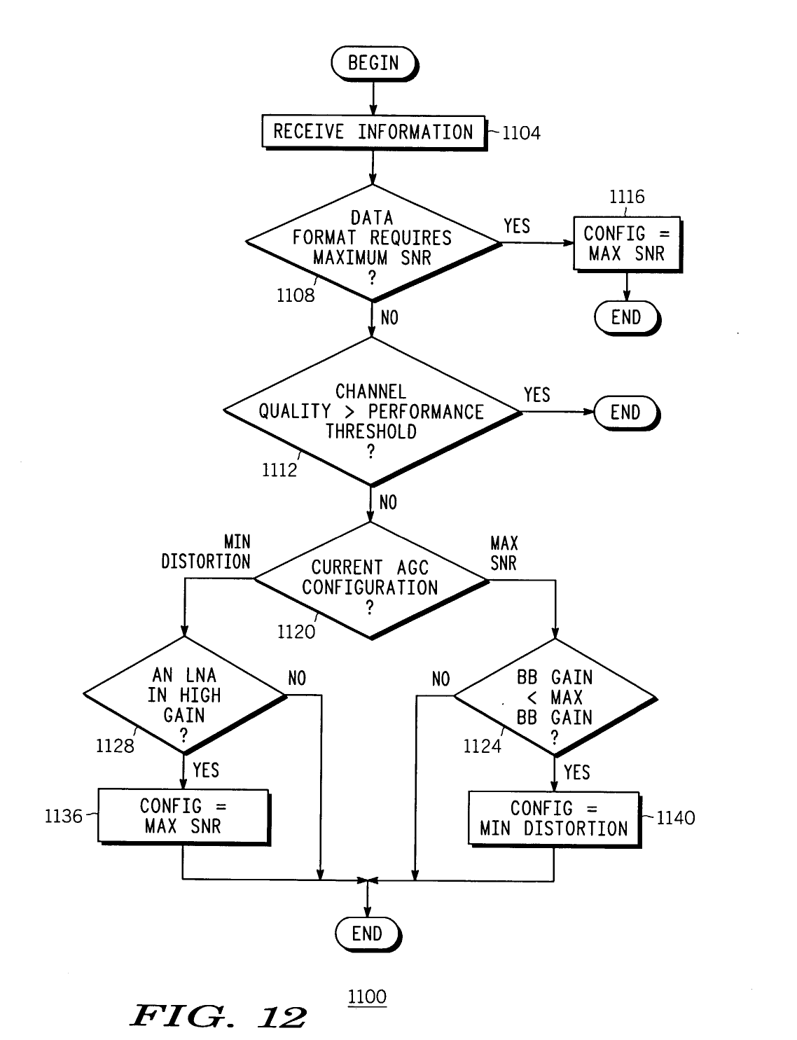

FIG. 12 is a simplified flow diagram of one embodiment of a method 1100 that may be used by gain control management software 1012 (FIG. 11) for generating configuration information. In particular, this embodiment provides a method for choosing between two configurations: 1) a maximum SNR mode (referred to as “MAX SNR”), and 2) a minimum distortion mode (referred to as “MIN DISTORTION”). In embodiments that employ a receiver such as receiver 600 of FIG. 6, MIN DISTORTION mode attempts to minimize gain on the analog front end so that any interference that may be present does not cause clipping distortion in MXRs 616A and 616B, and/or ADCs 628A and 628B. Similarly, in these embodiments, MAX SNR mode attempts to maximize gain on the analog front end so that SNR is maximized.

The flow of FIG. 12 will be described with reference to FIGS. 6, 7, and 10. In step 1104, gain control management software 1012 (FIG. 11) receives information, for example, from gain control device 1008, demodulator 1016, and communication protocol software 1020. In one embodiment for use in a cellular system and which includes a control device 640, such information may include, for example, one or more of the STEP1CONTROL, STEP2CONTROL, RSSI outputs of state machine 716, the ANALOG GAIN output of accumulator 718, the IN BAND POWER 1 output of converter 736, the IN BAND POWER 2 output of converter 764, the ANALOG GAIN output of accumulator 718, and the DIGITAL GAIN CONTROL output of device 740. In this embodiment, such information may include an indication, generated by communication protocol software 1020, whether packet or switched circuit communication format is currently being used. Also, such information may include a measure of channel quality generated by demodulator 1016.

In step 1108, it is determined whether the current communication format (i.e., packet or switched circuit) requires the configuration MAX SNR. If no, the flow proceeds to step 1112. If yes, the flow proceeds to step 1116 where the configuration is set to MAX SNR. Then, the flow ends.

In step 1112, it is determined whether the channel quality exceeds a performance threshold. If yes, the current configuration is acceptable and the flow ends. If no, the flow proceeds to step 1120. In step 1120, the current configuration is examined. If the current configuration is MAX SNR, then the flow proceeds to step 1124. If the current configuration is MIN DISTORTION, then the flow proceeds to step 1128. In step 1128, it is determined whether an LNA is in a high gain state. For example, in one embodiment that utilizes a receiver such as receiver 600 of FIG. 6, signals STEP1CONTROL and STEP2CONTROL are examined to determine if at least one of LNA 608 or LNA 612 is in its high gain state. If no, the configuration is kept as MIN DISTORTION and the flow ends. If, in step 1128 it is determined that at least one of LNA 608 or LNA 612 is in its high gain state, this might indicate that signal interference is low and the risk of distortion is reduced. Thus, the flow proceeds to step 1136, where the configuration is set to MAX SNR in attempt to maximize SNR. Then, the flow ends

In step 1124, it is determined whether a baseband gain is below a maximum baseband gain. For example, in one embodiment in which the signal DIGITAL GAIN CONTROL is provided to gain control management software 1012, this signal is examined to determine whether it is below a maximum gain threshold. If the signal DIGITAL GAIN CONTROL gain is below a maximum baseband gain, this might indicate that signal levels are high and, thus, that an interfering signal may be present. Thus, the flow proceeds to step 1140 where the configuration is set to MIN DISTORTION in an attempt to minimize distortion effects from a possible interfering signal. If no, the configuration is kept as MAX SNR and the flow ends.

While the invention is susceptible to various modifications and alternative constructions, certain illustrative embodiments thereof have been shown in the drawings and are described in detail herein. It should be understood, however, that there is no intention to limit the disclosure to the specific forms disclosed, but on the contrary, the intention is to cover all modifications, alternative constructions and equivalents falling within the spirit and scope of the disclosure as defined by the appended claims.

We claim:

1. An automatic gain control system, comprising:
a signal path configured to receive an input signal, the signal path including a first amplifier, the first amplifier having a control input;
a first signal level detector coupled to the signal path, the first signal level detector having a signal level output;
a gain control device having a first signal level input coupled to the signal level output of the first signal level detector, a first control output coupled to the control input of the first amplifier, and a gain control configuration input; and
a processor, coupled to the gain control configuration input of the gain control device, that is configured to monitor operating conditions and to reconfigure the gain control device in response to changes in the operating conditions.

2. The automatic gain control system of claim 1, wherein the first control output can be delayed by a first programmable delay amount.

3. The automatic gain control system of claim 1, wherein the signal path includes a second amplifier having a control input, and wherein the gain control device further has a second control output coupled to the control input of the second amplifier.

4. The automatic gain control system of claim 3, wherein the second control output can be delayed by a second programmable delay amount.

5. The automatic gain control system of claim 3, wherein the first amplifier is an analog amplifier and wherein the second amplifier is a digital amplifier.

6. The automatic gain control system of claim 5, wherein the analog amplifier is a step amplifier.

7. The automatic gain control system of claim 5, wherein the analog amplifier is an adjustable gain amplifier.

8. The automatic gain control system of claim 1, further comprising a second signal level detector coupled to the signal path, the second signal level detector having a signal level output, wherein the gain control device has a second signal level input coupled to the signal level output of the second signal level detector.

9. The automatic gain control system of claim 1, wherein the first signal level detector is coupled to a signal input of the first amplifier.

10. The automatic gain control system of claim 1, wherein the first signal level detector is coupled to a signal output of the first amplifier.

11. The automatic gain control system of claim 1, wherein the operating conditions include status information.

12. The automatic gain control system of claim 11, wherein status information includes a signal-to-interference ratio.

13. The automatic gain control system of claim 11, wherein status information includes a data rate.

14. The automatic gain control system of claim 11, wherein status information includes an indication of whether data is received using a circuit-switched protocol.

15. The automatic gain control system of claim 1, wherein a first configuration of the gain control device includes feed forward gain control, and wherein a second configuration of the gain control device includes feed back gain control.

16. A method in an automatic gain control system that includes a configurable automatic gain control device, the method comprising:
configuring the automatic gain control device to a first configuration based on first operating conditions;
detecting a change from the first operating conditions to second operating conditions; and
configuring the automatic gain control device to a second configuration based on the second operating conditions.

17. The method of claim 16, wherein first configuration is designed to reduce distortion.

18. The method of claim 16, wherein first configuration is designed to increase a signal-to-noise ratio.

19. The method of claim 16, wherein the automatic gain control device includes a first gain stage and a second gain stage.

20. The method of claim 19, wherein the first gain stage includes an analog amplifier and the second gain stage includes a digital amplifier.

21. The method of claim 16, wherein the automatic gain control device includes a first level detect device and a second level detect device.

22. The method of claim 16, wherein detecting a change from the first operating conditions to second operating conditions includes detecting a signal-to-interference level falling below a threshold.

23. The method of claim 16, wherein detecting the change from the first operating conditions to the second operating conditions includes detecting a change in a current communication format.

24. The method of claim 23, wherein detecting the change in a current communication format includes detecting a change from circuit-switched communication to packet-switched communication.

25. A radio frequency receiver, comprising:
a step gain stage having a radio frequency signal input, a radio frequency signal output, and a control input, the radio frequency signal input of the step gain stage coupled to receive a radio frequency signal;
a downconverter having a radio frequency signal input and a baseband signal output, the radio frequency signal input of the downconverter coupled to the radio frequency signal output of the step gain stage;
an analog variable gain stage having an analog signal input, an analog signal output, and a control input, the analog signal input of the analog variable gain stage coupled to the baseband signal output of the downconverter;
an analog-to-digital converter having an analog input and a digital output, the analog input of the analog-to-digital converter coupled to the analog signal output of the analog variable gain stage;
a digital filter having an input and an output, the input of the digital filter coupled to the digital output of the analog-to-digital converter;
a digital variable gain stage having a digital signal input, an digital baseband signal output, and a control input, the digital signal input of the digital variable gain stage coupled to the output of the digital filter;
an analog level detect device having a signal level output, the analog level detect device coupled to detect signal levels in the baseband signal output of the downconverter;
a digital level detect device having a signal level output, the digital level detect device coupled to detect signal levels in the output of the digital filter;
a control device having an analog level input, a digital level input, a gain control configuration input, a step gain control output, an analog variable gain control output, and a digital variable gain control output, the analog level input coupled to the signal level output of the analog level detect device, the digital level input coupled to the signal level output of the digital level detect device, the step gain control output coupled to the control input of the step gain stage, the analog variable gain control output coupled to the control input of the analog variable gain control stage, and the digital variable gain control output coupled to the control input of the digital variable gain control stage; and
a processor coupled to the gain control configuration input of the control device, wherein the processor is configured to monitor operating conditions and to configure the control device based on the operating conditions.

26. The radio frequency receiver of claim 25, wherein the control device comprises a state machine coupled to receive configuration information from the processor, wherein the state machine controls generation of the step gain control output, the analog variable gain control output, and the digital variable gain control output based on the configuration information.
